(19) United States
(12) Patent Application Publication
(10) Pub. No.: US 2013/0001188 A1
(43) Pub. Date: Jan. 3, 2013

(54) METHOD TO PROTECT MAGNETIC BITS DURING PLANARIZATION

(75) Inventors: David Kuo, Palo Alto, CA (US); Michael R. Feldbaum, San Jose, CA (US); Paritosh Rajora, Santa Clara, CA (US); Hieu Lam, Milpitas, CA (US)

(73) Assignee: SEAGATE TECHNOLOGY, LLC, Cupertino, CA (US)

(21) Appl. No.: 13/174,321

(22) Filed: Jun. 30, 2011

(51) Int. Cl. G11B 5/84; B05C 9/06; B32B 3/28; B05D 3/00; C23F 1/00; C23F 1/08; B05D 1/36

(52) U.S. Cl. 216/22; 156/345.1; 428/174

(57) ABSTRACT

The embodiments disclose a method to protect magnetic bits during carbon field planarization, including depositing a stop layer upon magnetic bits and magnetic film of a patterned stack, depositing a carbon fill layer on the stop layer and using the stop layer during planarization and etch-back of the carbon field to protect the patterned stack magnetic bits during the carbon field planarization.

### BACKGROUND

If carbon is used as the filler material for planarization, etch-back processes may etch the carbon filler material below the bit line damaging magnetic bits. An effective etch-back stop will protect magnetic bits from sub bit line etching during planarization.

### BRIEF DESCRIPTION OF THE DRAWINGS

FIG. 1 shows a block diagram of an overview of a method to protect magnetic bits during carbon field planarization of one embodiment.

FIG. 2 shows a block diagram of an overview flow chart of a method to protect magnetic bits during carbon field planarization of one embodiment.

FIG. 3 shows for illustrative purposes only an example of a silicon nitride stop layer vapor deposition process on a patterned stack of one embodiment.

FIG. 4A shows for illustrative purposes only an example of a deposited thin silicon nitride stop layer of one embodiment.

FIG. 4B shows for illustrative purposes only an example of a deposited thin silicon nitride stop layer with increased thickness of one embodiment.

FIG. 5A shows for illustrative purposes only an example of a deposited carbon fill layer of one embodiment.

FIG. 5B shows for illustrative purposes only an example of planarization etching of the carbon field of one embodiment.

FIG. 6A shows for illustrative purposes only an example of the silicon nitride stop layer protection of magnetic bits when the carbon field is etched to the bit line of one embodiment.

FIG. 6B shows for illustrative purposes only an example of the silicon nitride stop layer protection of magnetic bits when the carbon field is etched below the bit line of one embodiment.

FIG. 7 shows for illustrative purposes only an example of the silicon nitride stop layer removed to the bit line with the completion of a planarization process of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope.

### General Overview:

It should be noted that the descriptions that follow, for example, in terms of method to protect magnetic bits during carbon field planarization is described for illustrative purposes and the underlying system can apply to any number and multiple types patterned stacks and planarization processes. In one embodiment, the magnetic bits protection can be configured as a silicon nitride stop layer. In other embodiments the stop layer materials may include other materials for example silicon, silicon oxide, silicon carbide or silicon oxy-nitride. The stop layer may be configured to include adjustable deposition thicknesses.

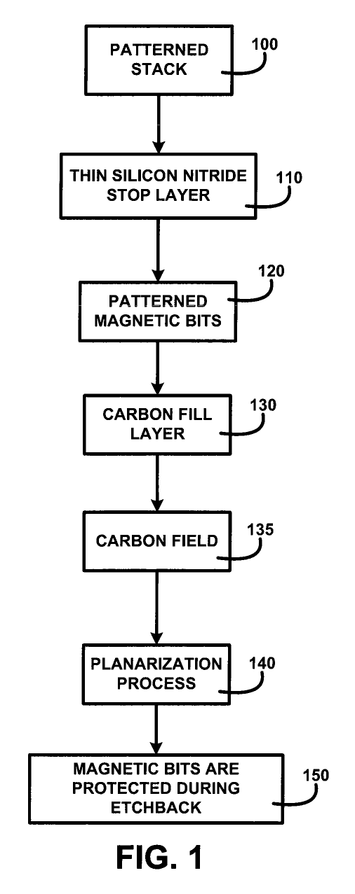

FIG. 1 shows a block diagram of an overview of a method to protect magnetic bits during carbon field planarization of one embodiment. The backfilling of areas of a patterned stack 100 with carbon materials may be performed to create a smooth protective surface on the patterned stack 100 for example a bit-patterned stack. The carbon materials are deposited to fill the recesses surrounding the raised magnetic bits. The carbon materials may include for example diamond-like carbon (DLC) which may be deposited above the level of the top of the magnetic bits. The backfilling of areas of with carbon materials forms a carbon fill layer 130. The portion of the carbon fill layer 130 that extends above the tops of the magnetic bits or bit line to the top surface of the carbon fill layer 130 forms the carbon field 135 that is subject to planarization. A method to protect magnetic bits during carbon field planarization deposits a thin silicon nitride stop layer 110 upon the topography of the patterned stack 100 including the patterned magnetic bits 120 and magnetic film. The deposition of the thin silicon nitride stop layer 110 is done prior to the depositing of the carbon backfill materials of one embodiment.

The thin silicon nitride stop layer 110 may be deposited using processes that may include for example Chemical Vapor Deposition (CVD), Plasma Enhanced Chemical Vapor Deposition (PECVD) and Reactive Ion Beam Deposition (RIBD); Ion Beam Deposition (IBD), Atomic Layer Deposition (ALD), or other processes. The deposition processes apply the thin silicon nitride stop layer 110 over the entire patterned surface of the patterned stack 100. The thicknesses of the thin silicon nitride stop layer 110 can be controlled to match the type of carbon material being used for a carbon fill layer 130 of one embodiment.

The carbon fill layer 130 has a portion of the deposited materials, the carbon field 135, removed in a planarization process 140. The planarization process 140 is used to smooth the surface to the tops of the patterned magnetic bits 120 or bit line. The planarization process 140 may include processes such as a Chemical Mechanical Process (CMP) where the chemical process includes an etching of the carbon fill layer 130 to remove the carbon field 135 or carbon material above the bit line, or other processes that may include for example Reactive Ion Etch (RIE) or Reactive Ion Beam etch (RIBE). A mechanical process may include a polishing process to reduce the height differences of the etching to create the smooth surface of one embodiment.

The chemical etching or etch-back of the carbon materials is stopped from affecting the patterned magnetic bits 120 by the thin silicon nitride stop layer 110. The thin silicon nitride stop layer 110 will not react with the chemicals that may be used in the etch-back process and the magnetic bits are protected during etch-back 150. The protection provided by the thin silicon nitride stop layer 110 preserves the magnetic integrity of the patterned magnetic bits 120 and magnetic film and the intended uses of their magnetic properties on the patterned stack 100. The method to protect magnetic bits during carbon field planarization allows the planarization of carbon backfilling to be used without damaging the magnetic bits and thus increases the quality of a patterned stack 100 such as a bit-patterned or discrete track media of one embodiment.

### Detailed Description:

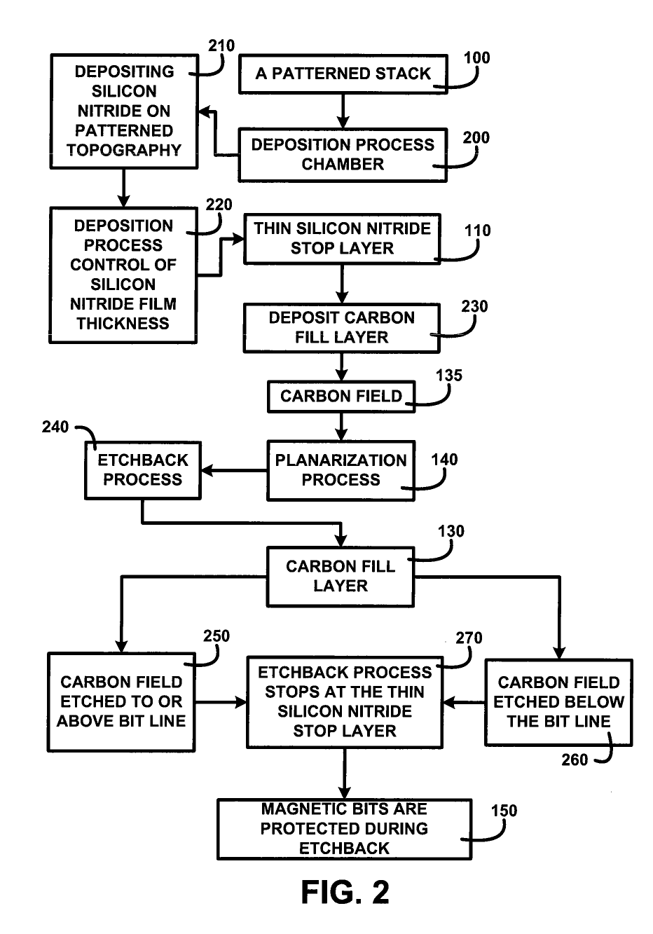

FIG. 2 shows a block diagram of an overview flow chart of a method to protect magnetic bits during carbon field planarization of one embodiment. The method to protect magnetic bits during carbon field planarization begins with the patterned stack 100 such as a bit-patterned or discrete track media and the deposit of the thin silicon nitride stop layer 110. One or more deposition processes may be used to deposit silicon nitride on the patterned stack 100 to form the thin silicon nitride stop layer 110. In one embodiment a deposition process to deposit the thin silicon nitride stop layer 110 may include Reactive Ion Beam Deposition (RIBD). The Reactive Ion Beam Deposition (RIBD) process injects gas compounds into the ion beam stream to deposit silicon nitride. The deposited silicon nitride is cured in a bake out that uses a temperature suitable for the chemistry chosen to harden the thin silicon nitride stop layer 110.

In another embodiment the thin silicon nitride stop layer 110 may be deposited using for example Chemical Vapor Deposition (CVD). A Chemical Vapor Deposition (CVD) process may include placing the patterned stack 100 in a deposition process chamber 200. The process may include depositing silicon nitride on patterned topography 210 using for example gas compounds that are injected into the deposition process chamber 200. The patterned stack 100 is heated and the injected gas compounds are deposited in thin films on the surfaces of the patterned stack 100 topography including the magnetic bits. A deposition process control of silicon nitride film thickness 220 is accomplished by control of the flow rate of gas compounds, temperature and pressure in the deposition process chamber 200. The deposited thin silicon nitride stop layer 110 forms an etch mask on the patterned stack 100 of one embodiment.

One or more processes may be used to deposit carbon fill layer 230 materials on the patterned stack 100 thin silicon nitride stop layer 110. The carbon fill materials may include one or more types of diamond-like carbon. A pure diamond-like carbon has properties such as hardness close to natural diamond. Other types of diamond-like carbon include other elements or compounds that may adjust the properties for example hardness and wear resistance. The method to protect magnetic bits during carbon field planarization allows the adjustment of the thin silicon nitride stop layer 110 thicknesses and composition to provide a range of protection of the magnetic bits for the various types of carbon fill materials.

The deposit of carbon fill layer 230 may be above the bit line of the magnetic bits and thin silicon nitride stop layer 110. The carbon fill layer 130 is smoothed and reduced in thickness to the bit line using one or more planarization process 140. The planarization process 140 creates smoothness of the contours of the patterned stack 100 topography surface by minimizing the step heights of the materials. The planarization process 140 may include chemical mechanical polishing planarization. A chemical mechanical polishing planarization process is used for smoothing surfaces with the combination of chemical and mechanical forces. The planarization chemical forces may include chemical etching of one embodiment.

The planarization chemical etching or etch-back process 240 may be used to reduce the thickness of the carbon field 135 to the bit line. The etch-back process 240 may result in a carbon field etched to or above bit line 250 or a carbon field etched below the bit line 260. The planarization etch-back process 240 may include for example a reactive ion beam etching of the carbon field 135 using a chemical such as oxygen gas (O₂) as the reactive agent of one embodiment.

The method to protect magnetic bits during carbon field planarization provides a structure wherein an etch-back process stops at the thin silicon nitride stop layer 270. The etch-back process stops because the chemical ingredients of the etch-back process 240 do not react with the thin silicon nitride stop layer 110. Magnetic bits are protected during etch-back 150 by the thin silicon nitride stop layer 110. The protection of the patterned magnetic bits 120 of FIG. 1 provided by the thin silicon nitride stop layer 110 eliminates damaging the magnetic bits and maintaining their designed magnetic field properties and predetermined functions of one embodiment.

### Deposition of Silicon Nitride:

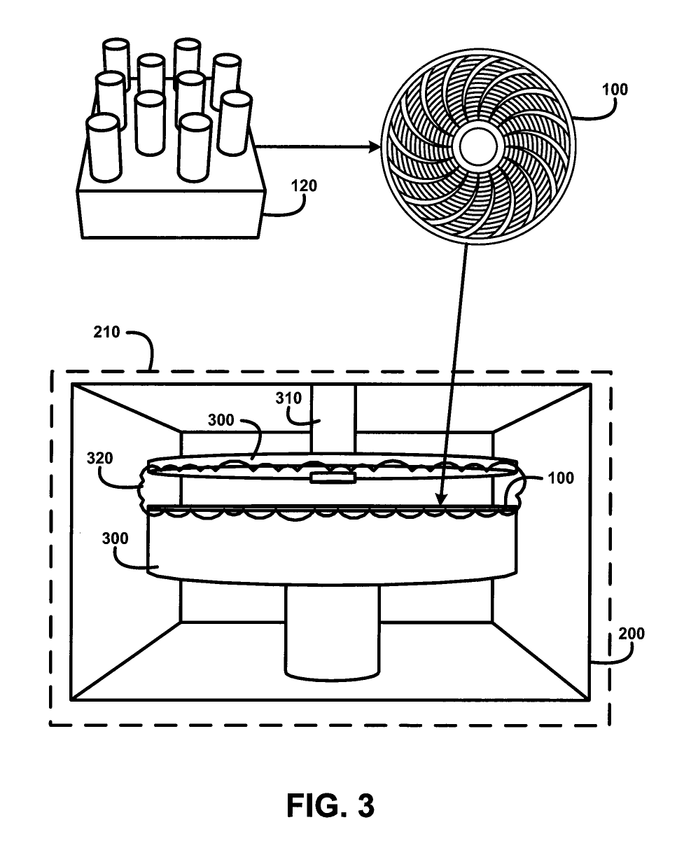

FIG. 3 shows for illustrative purposes only an example of a silicon nitride stop layer vapor deposition process on a patterned stack of one embodiment. Silicon nitride is a chemical compound of silicon and nitrogen. It is a hard ceramic having high strength over a broad temperature range, moderate thermal conductivity, low coefficient of thermal expansion, moderately high elastic modulus, and unusually high fracture toughness for a ceramic of one embodiment.

FIG. 3 shows an illustration of an example of patterned magnetic bits 120. The patterned magnetic bits 120 may be those of for example the patterned stack 100 such as a bit-patterned or discrete track media. The thin silicon nitride stop layer 120 of FIG. 1 of the method to protect magnetic bits during carbon field 135 planarization may be deposited for example using chemical vapor deposition (CVD) of one embodiment.

The chemical vapor deposition (CVD) process may include placing the patterned stack 100 in a deposition process chamber 200 as part of the process of depositing silicon nitride on patterned topography 210. The chemical vapor deposition (CVD) process may include positioning the patterned stack 100 between two electrodes 300. The two electrodes 300 may be used to heat the patterned stack 100 to a temperature suitable for the chemistry chosen for the processing of one embodiment.

The chemical reaction may include gaseous compounds 320 injected through a gas compounds delivery tube 310. The gaseous compounds 320 may include Silane (SiH4), Ammonia (NH3), Tetrachlorosilane (SiCl4) and Dichlorosilane (SiCl2H2). The pressure of the injected gas can be used to regulate the flow rate. The pressure, temperature, concentrations of the gas compounds and their flow rates and exposure times may be used to control the thicknesses of the silicon nitride film depositions. The gaseous compounds 320 in contact with the heated patterned stack 100 create a chemical reaction that deposits silicon nitride films to form the stop layer of one embodiment.

### Thin Silicon Nitride Stop Layer:

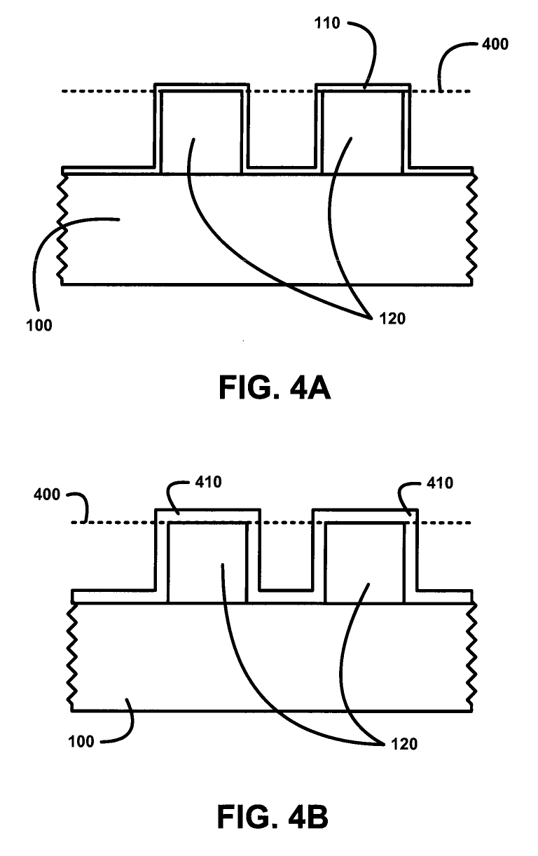

FIG. 4A shows for illustrative purposes only an example of a deposited thin silicon nitride stop layer of one embodiment. FIG. 4A shows the deposited thin silicon nitride stop layer 110 on the topography of the patterned stack 100. The silicon nitride deposits cover the entire topographical surfaces of the patterned stack 100 including the patterned magnetic bits 120. The thin silicon nitride stop layer 110 thickness rises above the bit line 400 of the patterned magnetic bits 120. The thin silicon nitride stop layer 110 provides protection of the patterned magnetic bits 120 in the etch-back process 240 of FIG. 2 that may be performed during the planarization process 140 of one embodiment.

### Adjustable Silicon Nitride Stop Layer Thicknesses:

FIG. 4B shows for illustrative purposes only an example of a deposited thin silicon nitride stop layer with increased thickness of one embodiment. FIG. 4B shows the deposition of the thin silicon nitride stop layer with increased thickness 410. The thickness of the silicon nitride deposition may be controlled in the deposition process. In a chemical vapor deposition process such as plasma-enhanced chemical vapor deposition (PECVD) pressures, concentrations of gas compounds and the flow rates, temperature and time in the process can be used to adjust the thicknesses of the silicon nitride films.

The thicknesses of the thin silicon nitride stop layer 110 of FIG. 1 may include adjustments to accommodate the type of materials used for the carbon fill layer 130 of FIG. 1. Some diamond-like carbon compounds have increased amounts of for example hydrogen. The thickness of the thin silicon nitride stop layer 110 of FIG. 1 deposited on the patterned stack 100 may be adjusted to provide the designed protection of the patterned magnetic bits 120. An increase of the thickness of the silicon nitride film deposition increases the protection over the bit line 400. The increased thickness may include a portion that would be removed during the etch-back process 240 for the particular type of diamond-like carbon of one embodiment.

### Carbon Field:

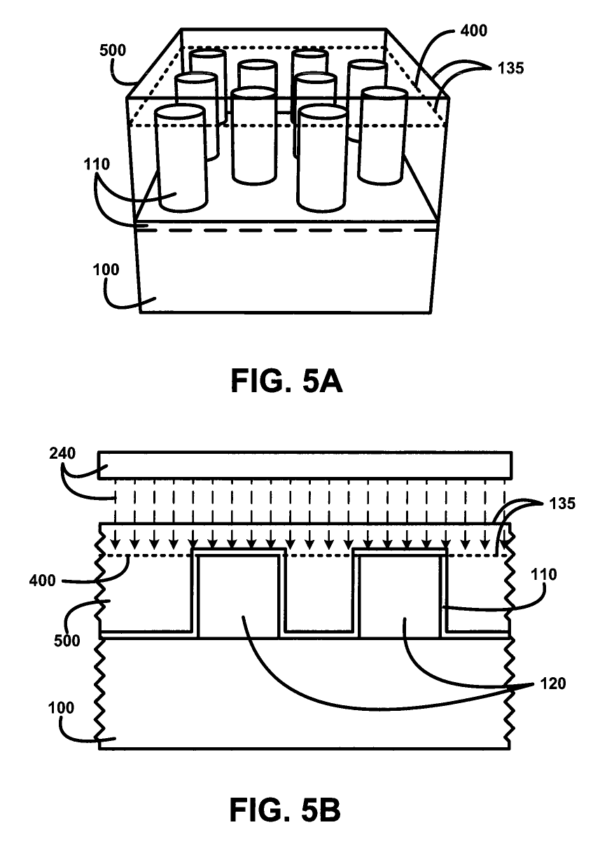

FIG. 5A shows for illustrative purposes only an example of a deposited carbon fill layer of one embodiment. FIG. 5A shows a carbon fill layer 130 of FIG. 1 that may be configured using a deposition of diamond-like carbon (DLC) 500. The deposition of diamond-like carbon (DLC) 500 is shown as transparent to allow a view of the underlying patterned magnetic bits 120 of FIG. 1 and other topography of the patterned stack 100 coated with the silicon nitride stop layer 110. The deposition of diamond-like carbon (DLC) 500 has been deposited upon the patterned stack 100 and the deposited thin silicon nitride stop layer 110.

The deposition of diamond-like carbon (DLC) 500 may be of a thickness that extends above the bit line 400. The portion of the DLC deposited above the bit line 400 forming the carbon field 135 may be removed using the planarization process 140 of FIG. 1. The planarization process 140 of FIG. 1 may include an etch-back process 240 of FIG. 2. The steps used in the planarization process 140 of FIG. 1 may include adjustments of the chemical etch compounds to provide a reaction with various carbon fill materials.

The carbon fill layer 130 of FIG. 1 may include diamond-like carbon (DLC) that for example includes pure diamond-like carbon (DLC) or other types of DLC that may include carbon compounds that include for example hydrogen, graphite sp2 carbon, and metals. The carbon compounds may vary in hardness, wear resistance, and slickness (DLC film friction coefficient).

The properties of the type of diamond-like carbon (DLC) may also differ with added materials such as the amounts and types of diluents added to reduce the cost of production. Other differences in the properties of the type of diamond-like carbon (DLC) may include the fractional content of hydrogen. Diamond-like carbon (DLC) production methods may include the use of hydrogen or methane as a catalyst. This may result in different percentages of hydrogen remaining in the finished DLC material. The variations that may be included in the carbon materials used to in the deposition of diamond-like carbon (DLC) 500 can be accommodated through the adjustments in the thicknesses of the thin silicon nitride stop layer 110 of one embodiment.

### Planarization Etch-Back:

FIG. 5B shows for illustrative purposes only an example of planarization etching of the carbon field of one embodiment. FIG. 5B shows the etch-back process 240 of the planarization process 140 of FIG. 1. The carbon fill layer 130 of FIG. 1 may include the deposition of diamond-like carbon (DLC) 500. The deposition of diamond-like carbon (DLC) 500 above the bit line 400 forms the carbon field 135 may be removed using the etch-back process 240.

The etch-back process 240 may include a reactive ion beam etching process that uses oxygen gas (O₂) as a reactive agent. The oxygen gas (O₂) reactive agent in the presence of the ion beam removes the carbon field 135 portion of the deposition of diamond-like carbon (DLC) 500. The thin silicon nitride stop layer 110 does not react with the oxygen gas (O₂) in reactive ion beam etching process. This stops the reactive ion beam etching at the thin silicon nitride stop layer 110 not allowing the etching to damage the patterned magnetic bits 120 of the patterned stack 100 of one embodiment.

### Silicon Nitride Stop Layer Bit Line Protection:

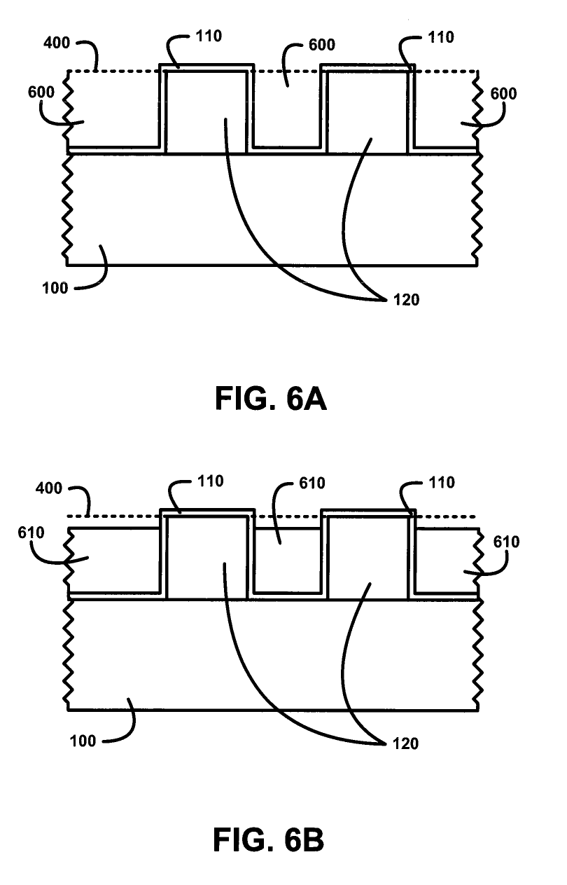

FIG. 6A shows for illustrative purposes only an example of the silicon nitride stop layer protection of magnetic bits when the carbon field is etched to the bit line of one embodiment. FIG. 6A shows a bit line etched carbon fill layer 600 wherein the etch-back process 240 of FIG. 2 has removed portions of the deposition of diamond-like carbon (DLC) 500 of FIG. 5A to the bit line 400. The thin silicon nitride stop layer 110 has stopped the etch-back process 240 of FIG. 2 in the areas above the patterned magnetic bits 120. Stopping the etch-back process 240 of FIG. 2 before it can damage the patterned magnetic bits 120 of the patterned stack 100 protects the magnetic field properties of the patterned magnetic bits 120 of one embodiment.

### Silicon Nitride Stop Layer Below Bit Line Protection:

FIG. 6B shows for illustrative purposes only an example of the silicon nitride stop layer protection of magnetic bits when the carbon field is etched below the bit line of one embodiment. FIG. 6B shows the thin silicon nitride stop layer 110 protecting the patterned magnetic bits 120 on the sides of the bits as well as the tops. The depositing silicon nitride on patterned topography 210 of FIG. 2 includes the formation of the thin silicon nitride stop layer 110 on all of the exposed surfaces of the patterned magnetic bits 120 and magnetic film.

This added protection coverage prevents damage from below bit line etched carbon field 610 results of the etch-back process 240 of FIG. 2. Damaging any of the surfaces of the patterned magnetic bits 120 including those below the bit line 400 may negatively impact the magnetic field properties on the patterned stack 100 of one embodiment.

### Silicon Nitride Stop Layer Planarization:

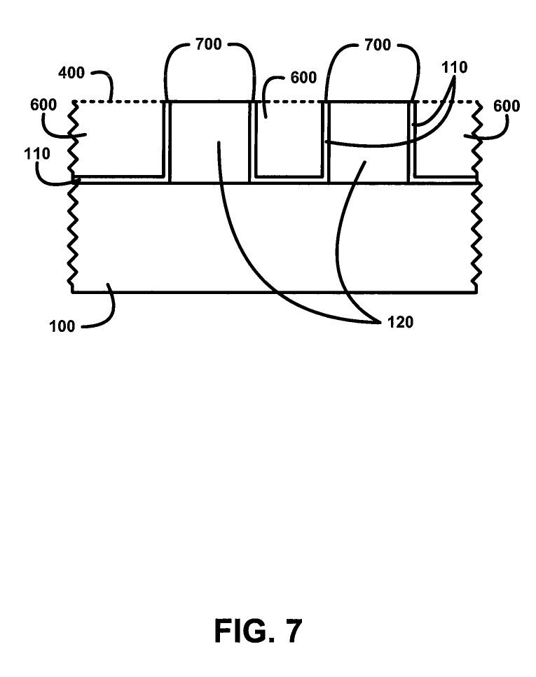

FIG. 7 shows for illustrative purposes only an example of the silicon nitride stop layer removed to the bit line with the completion of a planarization process of one embodiment. The thin silicon nitride stop layer 110 has protected the patterned magnetic bits 120 during the etch-back process 240 of FIG. 2 of the bit line 400 etched carbon fill layer 600. This has preserved the magnetic field properties of the patterned stack 100. The planarization process 140 of FIG. 1 may include mechanical polishing of the etched surface of one embodiment.

The mechanical polishing may include the removal of the portion 700 of the thin silicon nitride stop layer 110 on top of the patterned magnetic bits 120 to the bit line 400. This will provide the smoothness to the surface of the patterned stack 100. The thin silicon nitride stop layer 110 has prevented damage to the patterned magnetic bits 120. The method to protect magnetic bits during carbon field planarization has provided a cost effective and efficient means of fabricating patterned stack 100 products that may include for example bit-patterned and discrete track media using a carbon fill layer 130 of FIG. 1 of one embodiment.

The foregoing has described the principles, embodiments and modes of operation. However, the invention should not be construed as being limited to the particular embodiments discussed. The above described embodiments should be regarded as illustrative rather than restrictive, and it should be appreciated that variations may be made in those embodiments by workers skilled in the art without departing from the scope as defined by the following claims.

1. A method to protect magnetic bits during carbon field planarization, comprising:
depositing a stop layer upon magnetic bits and magnetic film of a patterned stack;
depositing a fill layer on the stop layer; and
using the stop layer during planarization and etch-back of the fill layer to protect the patterned stack magnetic bits during the carbon field planarization.

2. The method of claim 1, wherein depositing the stop layer includes adjustably controlling a thicknesses of the silicon nitride stop layer to prevent reaction with a planarization etch-back process.

3. The method of claim 1, wherein the stop layer includes one or more compounds including at least one of silicon nitride, silicon, silicon oxide, silicon carbide or silicon oxy-nitride.

4. The method of claim 3, wherein the composition of the stop layer is adjustable to prevent chemical reaction with a reactive agent of an etch-back process.

5. The method of claim 1, wherein the depositing of the stop layer includes using multiple deposition processes.

6. The method of claim 1, wherein the stop layer provides protection of the magnetic bits during multiple carbon field planarization processes including chemical mechanical planarization and reactive ion beam etching.

7. The method of claim 1, wherein the stop layer includes protection of the magnetic bits during planarization of carbon fields including at least one of pure diamond-like carbon of a carbon compound.

8. The method of claim 1, wherein the stop layer protects the magnetic bits during carbon field etch-back processes that extend below a bit line.

9. The method of claim 1, wherein the stop layer is cured prior to the carbon field filling.

10. An apparatus, comprising:
means for depositing a silicon nitride stop layer upon magnetic bits and magnetic film of a patterned stack;
means for depositing a fill layer on the silicon nitride stop layer; and
means for protect the patterned stack magnetic bits during the carbon field planarization by using the silicon nitride stop layer during planarization and etch-back of the fill layer.

11. The apparatus of 10, further comprising means for creating a stop layer structure in a patterned stack to protect magnetic bits during planarization.

12. The apparatus of 10, further comprising means for creating a stop layer structure in a patterned stack to protect magnetic bits during planarization wherein the etch-back processes may etch below a bit line.

13. The apparatus of 10, further comprising means for depositing the silicon nitride stop layer that includes one or more compounds including at least one silicon nitride, silicon, silicon oxide, silicon carbide or silicon oxy-nitride to form a stop layer upon magnetic bits and magnetic film of a patterned stack in adjustable deposition thicknesses.

14. The apparatus of 10, further comprising means for depositing a silicon nitride stop layer using plural deposition processes.

15. The apparatus of 10, further comprising means for depositing one or more compounds with different chemical compositions to prevent reaction with multiple types of planarization reactive etch-back processes.

16. A carbon field planarization stop layer structure, comprising: a silicon nitride stop layer, wherein the stop layer is deposited upon patterned magnetic bits to protect the patterned magnetic bits during a carbon field planarization etch-back process.

17. The carbon field planarization stop layer structure of claim 16, wherein the thickness of the deposition of the silicon nitride stop layer is adjustable.

18. The carbon field planarization stop layer structure of claim 16, wherein the silicon nitride stop layer includes one or more compounds.

19. The carbon field planarization stop layer structure of claim 16, wherein the silicon nitride stop layer is used as protection for planarization of carbon fields including at least one of pure diamond-like carbon or a carbon compound.

20. The carbon field planarization stop layer structure of claim 16, wherein the stop layer structure protects magnetic bits during planarization of a carbon field, wherein etch-back processes may etch below a bit line.
